(19) United States
(12) Patent Application Publication
(10) Pub. No.: US 2009/0109472 A1
(43) Pub. Date: Apr. 30, 2009

(54) Image Transmission System

(75) Inventors: Minako Kobayashi, Ikeda-shi (JP); Hirohisa Miyamoto, Kobe-shi (JP); Takehisa Yamaguchi, Ikoma-shi (JP); Katsuhiko Akita, Amagasaki-shi (JP); Okihisa Yoshida, Amagasaki-shi (JP)

Correspondence Address: BUCHANAN, INGERSOLL & ROONEY PC, POST OFFICE BOX 1404, ALEXANDRIA, VA, 22313-1404, US

(73) Assignee: KONICA MINOLTA BUSINESS TECHNOLOGIES, INC., Chiyoda-ku (JP)

(21) Appl. No.: 12/252,480

(22) Filed: Oct. 16, 2008

(30) Foreign Application Priority Data
Oct. 31, 2007 (JP) 2007-283514

(51) Int. Cl. G06F 3/12

(52) U.S. Cl. 358/1.15

(57) ABSTRACT

The subject matter of the present invention described herein is an image transmission system in which an image transmission apparatus uses configuration that has been set in a server. The image transmission apparatus acquires identifiers from the server, and displays the identifiers on a UI screen based on the acquired identifiers. Upon receiving a selection from the UI screen, the image transmission apparatus acquires an address corresponding to the selected identifier from the server, and uses the address for transmission of image data.

This application is based on application No. 2007-283514 filed in Japan, the content of which is hereby incorporated by reference.

### BACKGROUND OF THE INVENTION

(1) Field of the Invention

The present invention relates to an image transmission apparatus that uses, when transmitting image data, information that is related to a transmission destination that is stored in a server.

(2) Description of the Related Art

There have been conventional techniques to improve convenience for the users by enabling a server to centrally control a database that includes addresses to be used for transmission, such that many clients share the database.

In particular, there has been a technique to respond to change of addresses in the database. Such a technique is disclosed in, for example, Japanese Laid-open Patent Application Publications No. 2003-244308, No. 2003-108479, No. 2005-33733, and No. 2006-20049.

Regarding reception of image data transmitted by the image transmission apparatus, the inventor of the present invention is considering implementing a new function of allowing recipients to receive the data in a desired manner.

If implementing such a function, it is anticipated that the users often change the distribution mode to use. Although it is possible to simply reflect the mode after the change to the image transmission apparatus at every change to prevent the data from being transmitted by the previous mode, this increases the processing load on the image transmission apparatus.

The increased processing load lowers the response speed of the image transmission apparatus (i.e. the speed the users actually feel). Therefore, it is necessary to avoid that the mode changes are reflected to the image transmission apparatus too often.

Such a problem is not limited to the case of the data change by the users (recipients), but generally happens when data stored in the server is changed.

The present invention is made in view of the problem above. The object of the present invention is to provide an image processing apparatus and so on that is capable, when information about transmission destinations of the image transmission apparatus is changed, of using the new information with suppressing decrease of the response speed as much as possible.

### SUMMARY OF THE INVENTION

To fulfill the stated object, an aspect of the present invention is an image transmission system that includes a server and an image transmission apparatus as a client which are connectable to each other, the server comprising a storage storing therein identifiers of one or more recipients and addresses corresponding thereto, and the image transmission apparatus comprising: a first acquisition part operable to acquire the identifiers from the server; a menu display part operable to display a menu of selectable transmission destinations based on the acquired identifiers; a second acquisition part operable to acquire, from the server, one of the addresses corresponding to a selected one of the transmission destinations; and a transmission part operable to transmit data to the acquired one of the addresses.

With the stated structure, for example, the address used for transmission is acquired after the transmission destination is confirmed by the selection. Accordingly, it is possible to use the newest address at the transmission. As a result, even if the address is changed immediately before the data is transmitted, it is possible to handle this change. Also, it is possible to reduce the frequency of merges of acquired data. This realizes quick menu display and data acceptance, and does not keep the user waiting.

Another aspect of the present invention is an image transmission apparatus that is connectable to a server that stores therein identifiers of recipients and addresses corresponding thereto, the image transmission apparatus comprising: a first acquisition part operable to acquire the identifiers from the server; a menu display part operable to display a menu of selectable transmission destinations based on the acquired identifiers; a second acquisition part operable to acquire, from the server, one of the addresses corresponding to a selected one of the transmission destinations; and a transmission part operable to transmit data to the acquired one of the addresses.

Another aspect of the present invention is an address server that is connectable to an image transmission apparatus as a client, the address server comprising: a storage operable to store therein identifiers of one or more recipients and addresses corresponding thereto; an accepting part operable to accept a change to the addresses; a judgment part operable to judge whether the image transmission apparatus has possibilities of using the addresses that have not been changed; and a transmission part operable to transmit the addresses that have been changed, to the image transmission apparatus if the judgment part judges affirmatively.

With the stated structures, it is possible to prevent that the old address is used by the image transmission apparatus such that the new address is used. Also, the new address is transmitted only if there are possibilities of use, such that it is possible to avoid increase of the processing load on the image transmission apparatus.

### BRIEF DESCRIPTION OF THE DRAWINGS

These and the other objects, advantages and features of the invention will become apparent from the following description thereof taken in conjunction with the accompanying drawings which illustrate a specific embodiment of the invention. In the drawings:

FIG. 1 shows a network structure;

FIG. 2 shows a control block diagram of an MFP 10;

FIG. 3 shows a control block diagram of a server 100;

FIG. 4 shows tables showing an example of a data structure of a per-user address book 114;

FIG. 5 is a table showing an example of a data structure of a recipient-configuration address book 116;

FIGS. 6A, 6B and 6C show a pattern of recipient configurations that have been set and are to be used by a user B;

FIGS. 7A, 7B and 7C are time-series conceptual drawings showing a specific example case 1;

FIG. 8 is a flowchart of the specific example case 1, showing processing performed by a controller 20 of the MFP 10 of the specific example 1;

FIG. 9 is an example screen for displaying items at Step S15 of FIG. 8;

FIG. 10 is an example screen corresponding to item confirmation displayed at Step S16 of FIG. 8;

FIG. 11 is a flowchart showing processing performed by the controller 20 of the MFP 10 of a specific example 2;

FIG. 12 is a management table held by a user management unit 104; and

FIG. 13 is a flowchart showing processing performed by the server 100 and the MFP 10 pertaining to the second embodiment.

### DESCRIPTION OF THE PREFERRED EMBODIMENTS

### First Embodiment

The following describes an image transmission system pertaining to the first embodiment of the present invention, with reference to the drawings.

### <Structure>

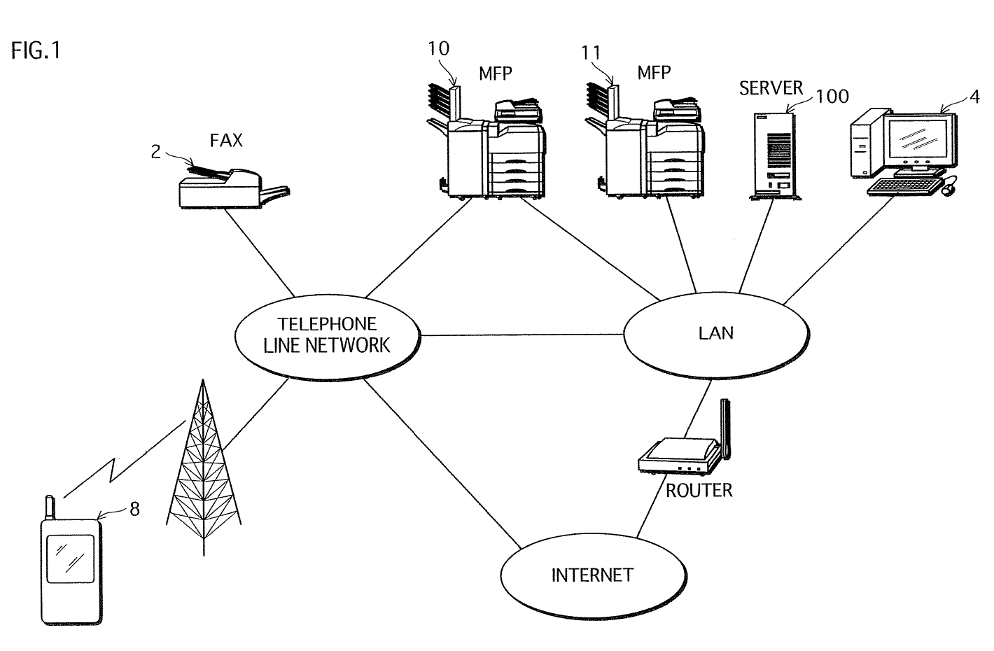

FIG. 1 shows a network structure.

The image transmission system includes a FAX 2, a PC 4, a portable terminal apparatus 8, MFPs 10 and 11, and a server 100.

The portable terminal apparatus 8 has, for example, a voice call function utilized via a telephone line, an e-mail function, and a web browser function.

The MFPs (Multi Function Peripherals) 10 and 11 are apparatuses that each has functions of a FAX, a printer, a scanner, a mailer and so on.

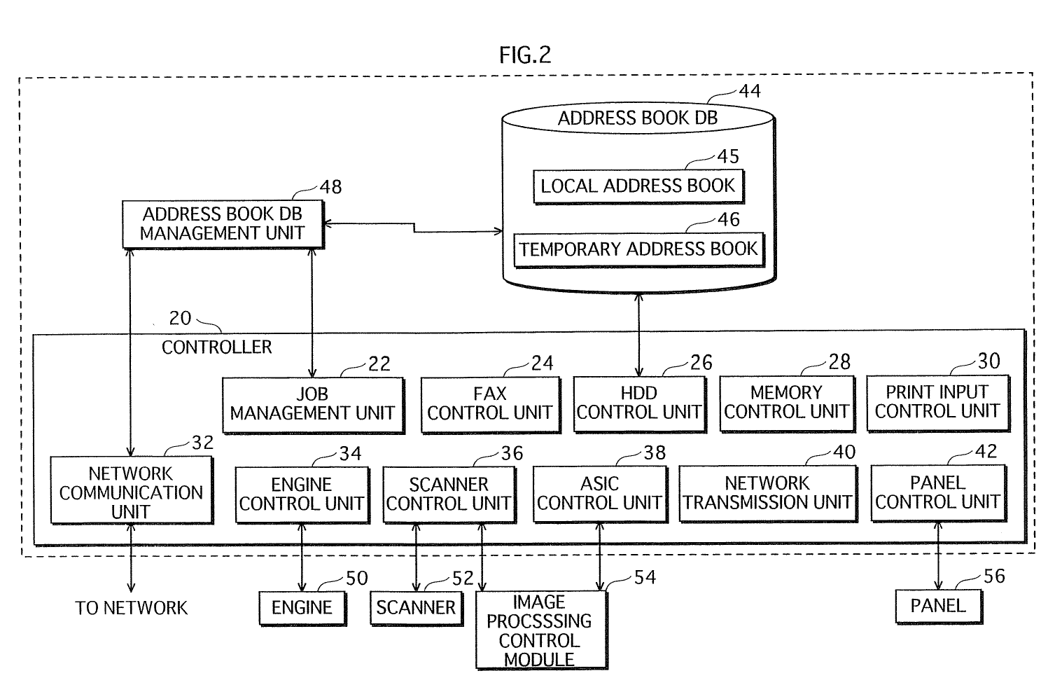

FIG. 2 shows a control block diagram of the MFP 10. The MFP 11 has the same structure as the structure of the MFP 10.

A controller 20 includes a job management unit 22, a fax control unit 24, a HDD control unit 26, a memory control unit 28, a print input control unit 30, a network communication unit 32, an engine control unit 34, a scanner control unit 36, an ASIC control unit 38, a network transmission control unit 40, and a panel control unit 42.

The job management unit 22 manages jobs relating to printing and faxing. If a job relates transmission, the job management unit 22 acquires an address from an address book DB management unit 48. The Fax control unit 24 controls fax reception and transmission.

The HDD control unit 26 controls an address book DB 44 stored in a HDD (Hard Disk Drive). The memory control unit 28 controls a RAM and a ROM.

The print input control unit 30 controls an input of a print instruction. The network communication unit 32 controls network communications. The engine control unit 34 has mechanical controls of an engine 50 and so on. The scanner control unit 36 controls the scanner 52. The ASIC control unit 38 controls an ASIC (Application Specific Integrated Circuit) and also controls an image processing control module 54.

The network transmission control unit 40 controls e-mails and several types of protocols, such as SMB (Server Message Block), FTP (File Transfer Protocol), WebDAV (Distributed Authoring and Versioning protocol for the WWW) to transmit (distribute) data.

The panel control unit 42 displays screens and the likes on the panel 56 and accepts an input from the panel 56 which has a touch sensor. In particular, the panel control unit 42 displays a login screen to accept login of a user.

The address book DB 44 is under management by the address book DB management unit 48, and includes a local address book 45 and a temporary address book 46.

The local address book 45 is an address book locally stored in the HDD of the MFP 10. The temporary address book 46 is an address book that has been downloaded from the remote server 100.

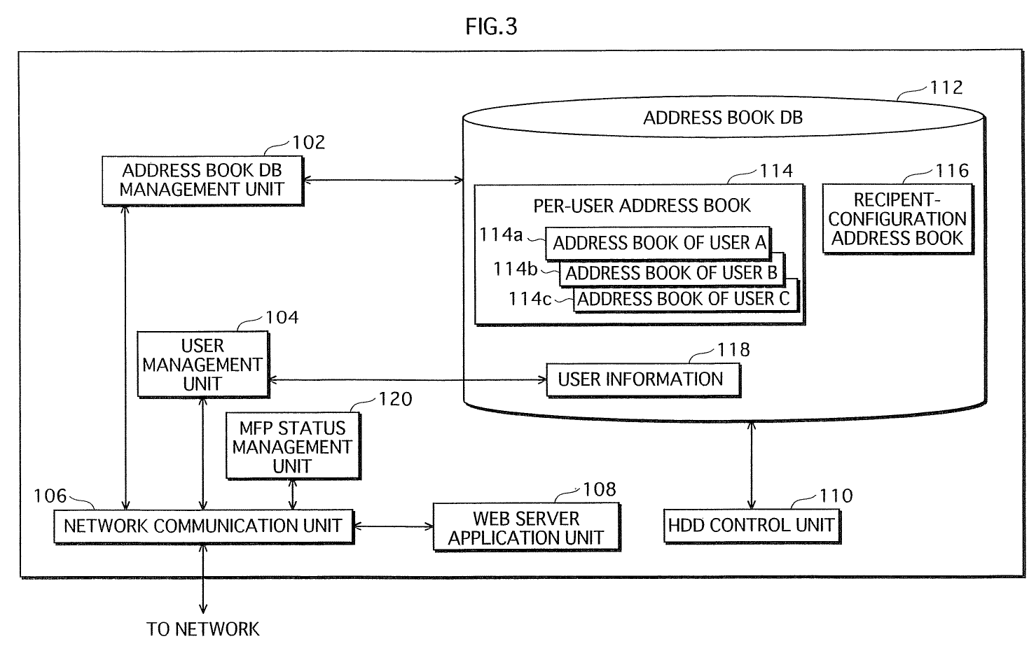

FIG. 3 shows a control block diagram of the server 100.

An address book DB management unit 102 manages an address book DB 112. A user management unit 104 manages user information 118.

A network communication unit 106 controls network communications.

A web server application unit 108 provides HTML files and so on prestored therein, in response to HTTP requests from external apparatuses.

An HDD control unit 110 controls the address book DB 112 stored in the HDD.

An MFP status management unit 120 manages statuses of use of the MFP 10 and the MFP 11 that are under control of the server 100.

The address book DB 112 includes a per-user address book 114, a recipient-configuration address book 116 and user information 118.

The per-user address book 114 includes address books 114a to 114c for users A, B and C.

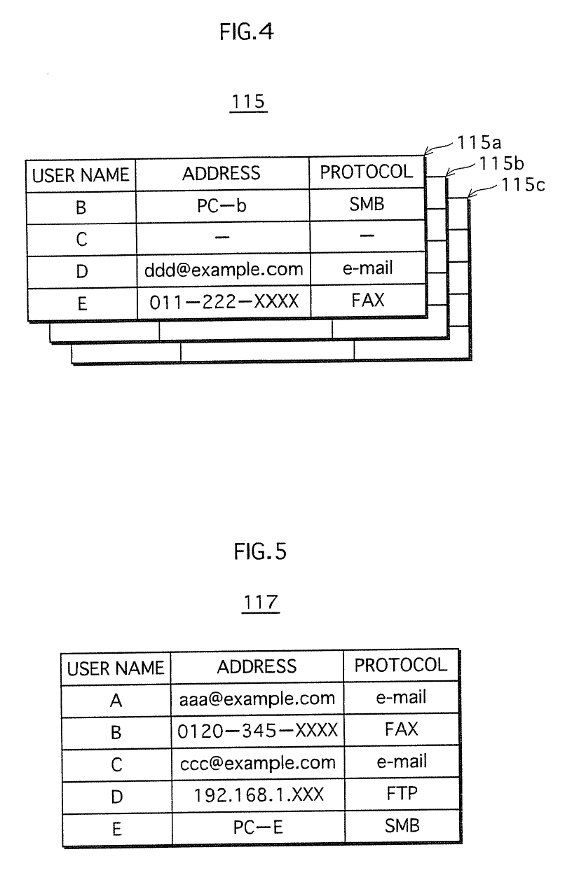

FIG. 4 is a group of tables showing an example of a data structure of the per-user address book 114.

The table group 115 is structured from tables 115a to 115c for the users A to C. Each table includes three items, namely “name” as the transmission destination, “address” of the transmission destination, and “protocol” showing a method used for the transmission to the destination.

In this way, the address books included in the per-user address book 114 are respectively managed for the users A, B and C as senders. Therefore, the per-user address book 114 can be regarded as a “per-sender address book”.

The recipient-configuration address book 116 is an address book in which a desired distribution mode is configured for each recipient.

FIG. 5 is a table showing an example of a data structure of the recipient-configuration address book 116.

A table 117 of FIG. 5 is an example of a data structure of the recipient-configuration address book 116. The table 117 includes items of “name” of a user who has registered the recipient, “address”, and “protocol”.

<Summary of Recipient configuration>

Before explaining the specific example of the embodiments of the present invention, the following briefly describes the way in which a user uses the recipient' configuration when transmitting data.

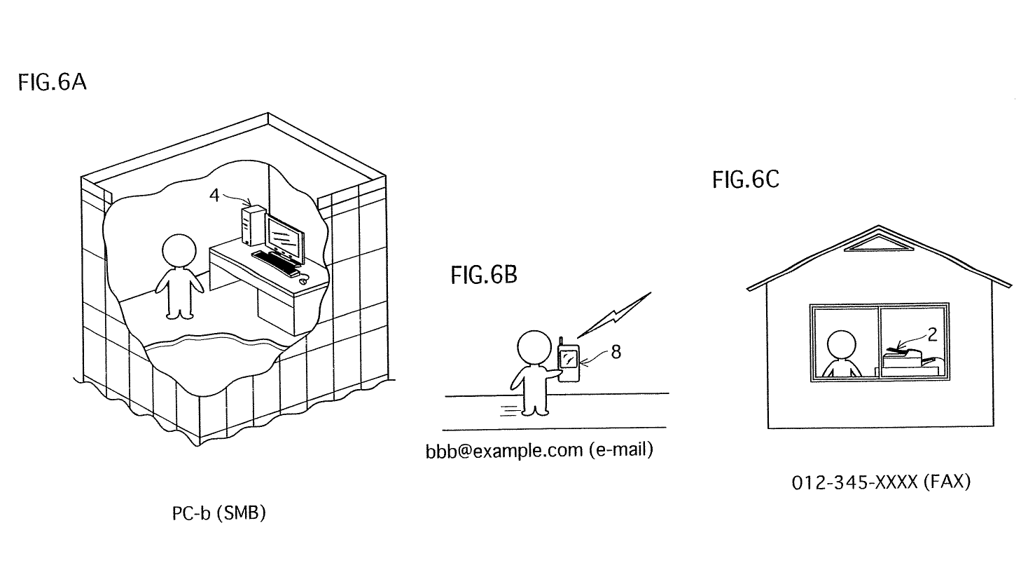

FIGS. 6A, 6B and 6C show a pattern of configurations that have been set and to be used by a user B.

It is assumed that the user B separately uses three configurations, namely a configuration for receiving data by the PC 4 at an office (FIG. 6A, SMB: PC-b), a configuration for receiving data by the portable terminal apparatus 8 when the user is out on the streets (FIG. 6B, e-mail: bbb@example.com), and a configuration for receiving data by the FAX 2 at home (FIG. 6C, FAX: 012-345-XXXX).

The user B can select a distribution mode that is suitable for his action pattern or his preference by changing the configuration of the recipient-configuration address book 116.

### SPECIFIC EXAMPLE 1

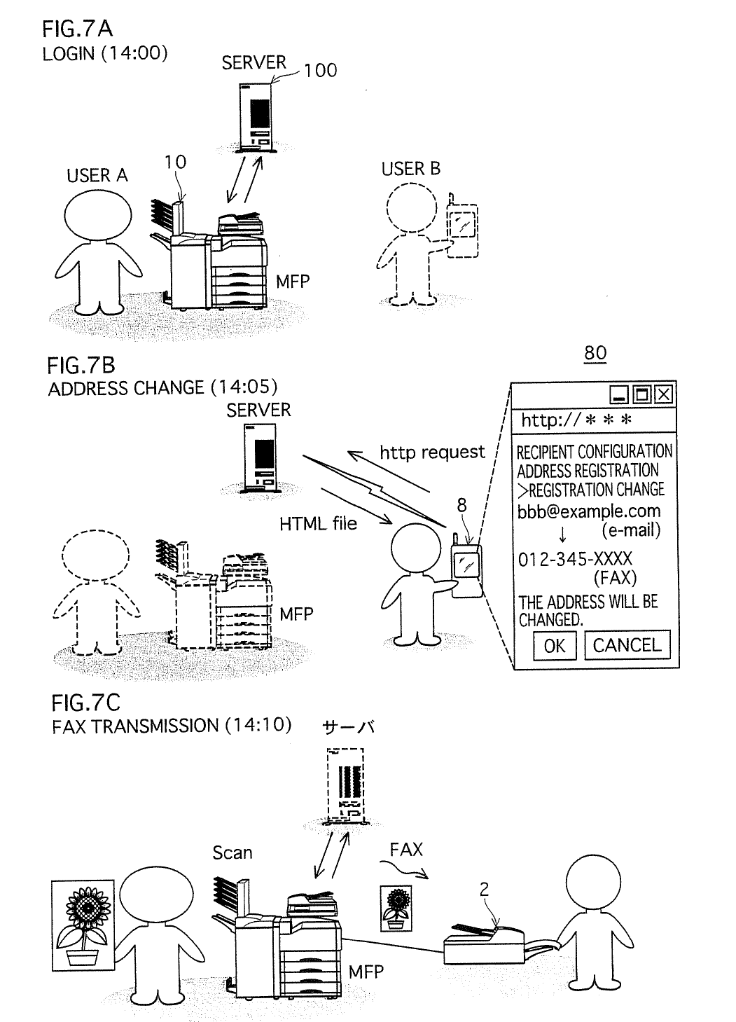

FIGS. 7A, 7B and 7C are time-series conceptual drawings showing a case of the specific example 1;

(1) At 14:00, the user A logs into the MFP 10 [FIG. 7A].

(2) At 14:05, the user B changes his recipient-configurations (from e-mail: bbb@example.com to FAX: 012-345-XXXX) in the server 100, via a web browser screen 80 of the portable terminal apparatus 8 [FIG. 7B].

(2) At 14:10, the user A scans a document, and transmits the scan data to the user B in accordance with the new recipient-configuration.

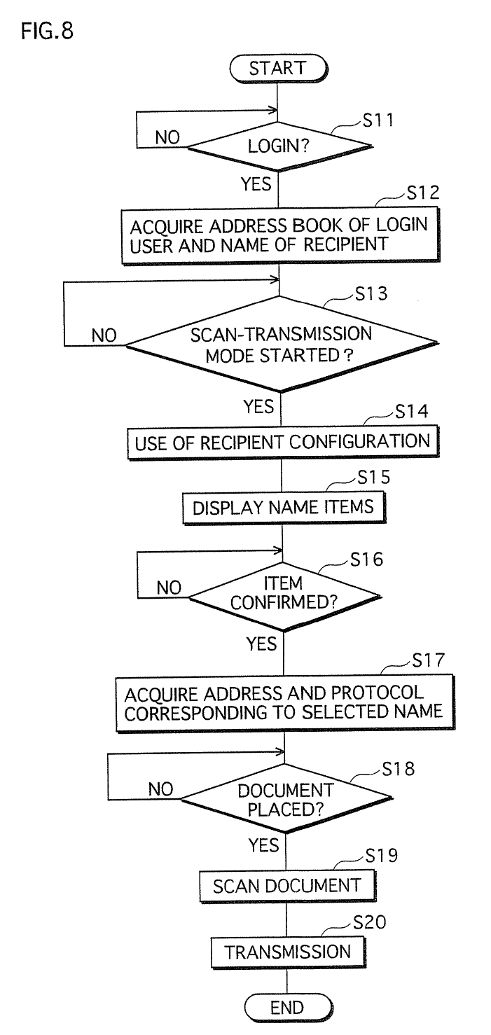

FIG. 8 is a flowchart of the specific example case 1, showing processing performed by the controller 20 of the MFP 10 of the specific example 1.

When a user logs in, the MFP 10 acquires a per-sender address book of the login user and names of recipients who have registered their recipient configurations (Step S11: YES, and Step S12). At this moment, it is preferable that the MFP does not acquire the addresses and the protocols configured by the recipients to suppress the processing load on the MFP 10 due to merging of the acquired data.

If the user A logs into the MFP 10, the MFP 10 acquires the address book 114a of the user A (see FIG. 3) and user names (user B, user C, user D and user E) included in the recipient-configuration address book 116.

When the scan-transmission mode is started (S13: YES), the MFP 10 uses the recipient-configurations as the transmission destinations (Step S14), and displays the acquired user names as selectable items indicating transmission destinations (Step S15). Note that although the recipient-configurations are unconditionally used in Step S14, it may be possible to selectively use the address book of the login user acquired in Step S11.

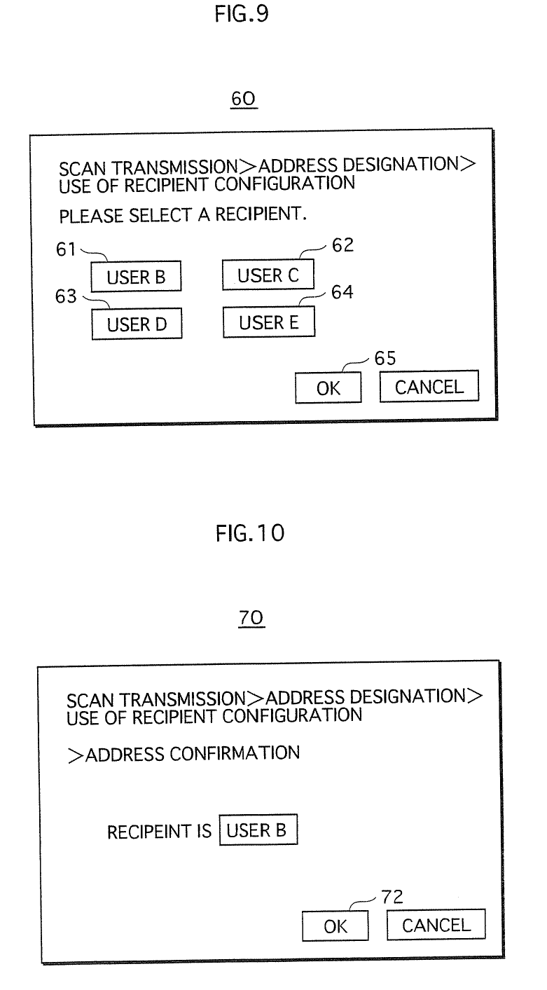

FIG. 9 is an example screen for displaying the selectable items at Step S15 of FIG. 8.

A, panel screen 60 shows selectable items “USER B” 61 to “USER E” 64 as the transmission destinations. When an OK key 65 is touched with any of the items 61 to 64 being selected, a panel screen 70 shown in FIG. 10 prompts the login user to confirm the transmission destination.

Again, in FIG. 8, when the item is confirmed (Step S16: YES), the MFP 10 acquires an address and a protocol corresponding to the name of the confirmed item, from the recipient-configured address book (S17).

If a document is set on the reading tray of the MFP 10 (Step S18: YES), the MFP 10 scans the document (Step S19) to generate image data, and transmits the image data to the acquired address using the corresponding protocol (Step S20).

### SPECIFIC EXAMPLE 2

In the specific example 1, the MFP 10 acquires only the names of the recipients who have registered their recipient configurations at the firs acquisition (S12), and acquires the address and the protocol at the second acquisition (Step S17). However, it is possible to acquire the address and the protocol at the first acquisition to use them for displaying the items afterwards. The specific example 2 explains such a case.

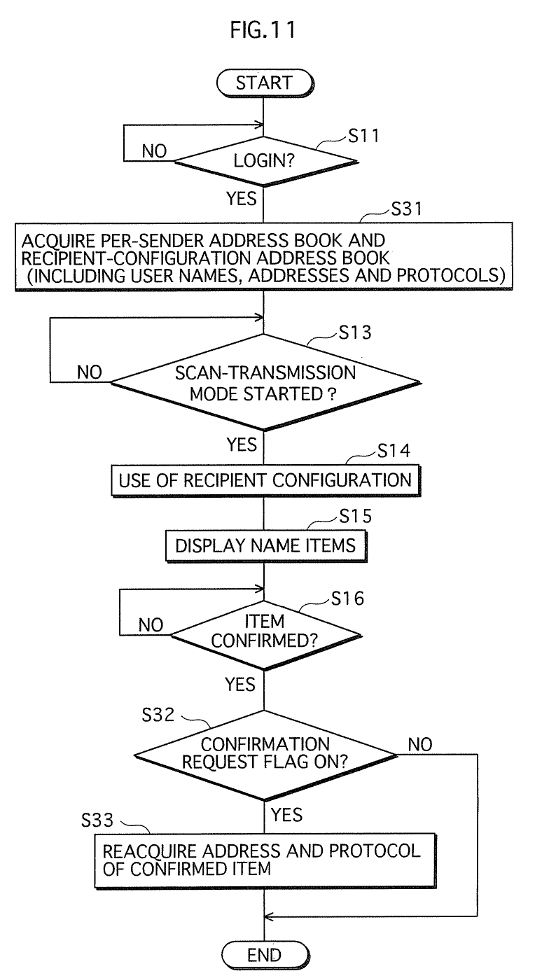

FIG. 11 is a flowchart showing processing performed by the controller 20 of the MFP 10 of a specific example 2.

In FIG. 11, the same numbers are given to the steps that are the same as those in FIG. 8, and explanations thereof are omitted here.

After the user logs in the MFP 10 (Step S11), the MFP 10 acquires the per-sender address book of the login user and groups of the name, the address and the protocol included in the recipient-configuration address book (S31).

After the item is confirmed (S16), if a check-request flag has not been set (S32: No), the MFP 10 transmits the data using the acquired address and protocol (Step S31). If a check-request flag has been set (S32: YES), the MFP 10 reacquires the address and the protocol of the confirmed item (Step S33). As a result of the re-acquisition, the MFP lo acquires the address and the protocol that are newer than those acquired previously. Therefore, it is possible to handle the changes of the address and so on. Here, the check request flag may be manually set according to the user's preference.

Also, it may be automatically set based on the degree of the possibilities that the acquired information has been changed. For example, it may be automatically set if a long time has been elapsed from the acquisition.

### Second Embodiment

In the first embodiment, the MFP 10 acquires the address and so on immediately before transmitting data so as to handle the change of the address and so on. In the second embodiment, however, the server 100 transmits differential data to the MFP 10 to handle the change.

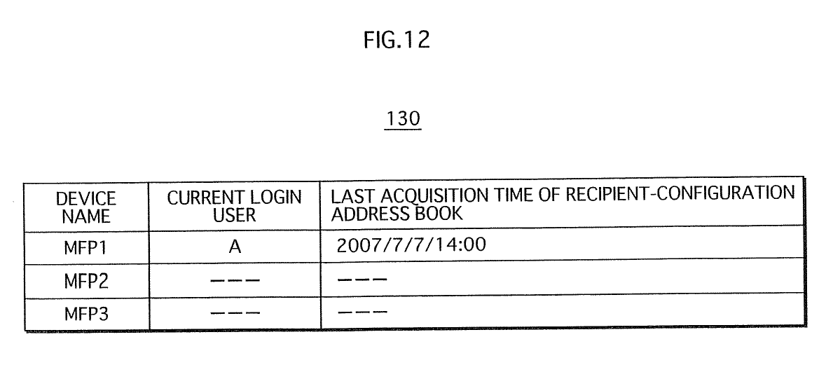

FIG. 12 is a management table held by the user management unit 104.

A management table 130 includes items “device name”, “current login user” and “last acquisition time of recipient-configuration address book”.

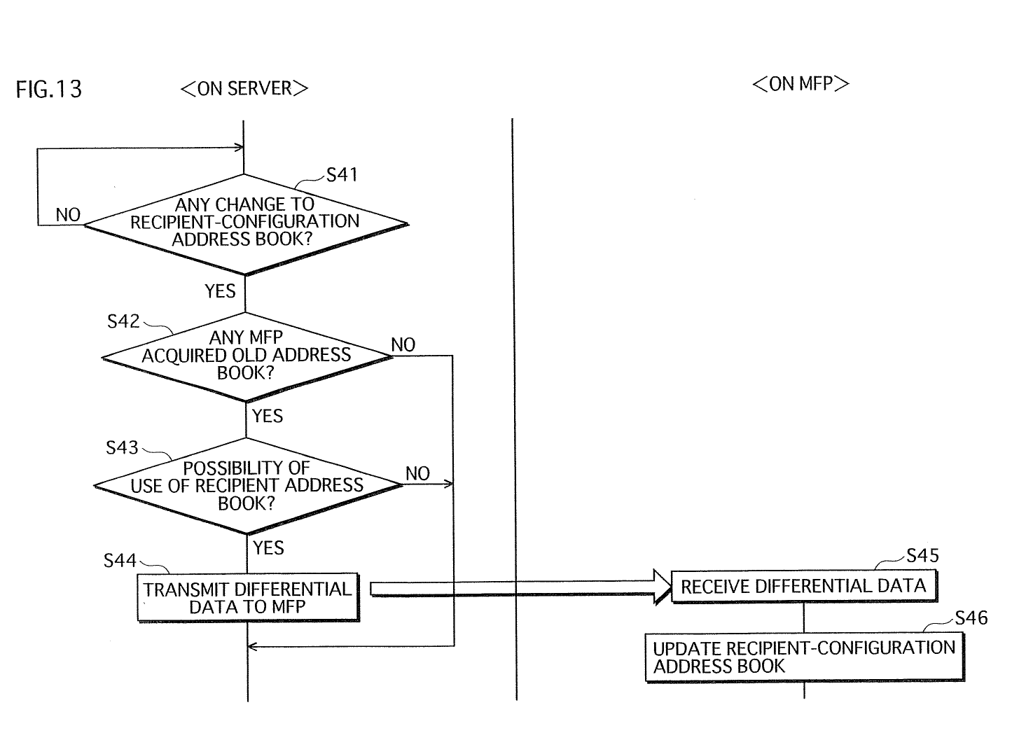

FIG. 13 is a flowchart showing processing performed by the server 100 and the MFP 10 pertaining to the second embodiment.

If the content of the recipient-configuration address book 116 has been changed (Step S41: YES), the server 100 judges whether there is any MFP that had acquired the old content. This judgment is performed with reference to the last acquisition times included in the management table 130.

If there is a possibility that a certain MFP will use the old content of the recipient-configuration address book 116 (Step S43: YES), the server 100 transmits differential data between the old content and the changed content of the address book to the MFP (Step S44). On the other hand, the MFP 10 receives the differential data (step S45), and updates the acquired recipient-configuration address book based on the differential data (Step S46).

Note that the possibility of use of the recipient-configuration address book 116 can be judged in the following manner: For example, in the case where the recipient-configuration address book of FIG. 7 is changed by the user B (from e-mail: bbb@example.com to FAX: 012-345-XXX), the server 100 refers to the items “device name” and “current login user name” included in the management table 130 (see FIG. 12), and judges that there is a possibility of use of the recipient-configuration address book as to the “MFP 1”, into which the user A is currently logging in, based on an transmission instruction input by the user A. On the other hand, the server 100 judges that there is no possibility as to the “MFP 2” and the “MFP 3”, into which no use is currently logging in.

Then, the server 100 transmits the new recipient-configuration address book to the MFP 1 as to which the server 100 judges that there is a possibility so as to prevent the login user A of the MFP 1 from using the old address (e-mail: bbb@example.com) for the transmission.

The judgment as to the possibility may be performed based on, for example, the relation between the login user A of the MFP 1 and the user B who has changed the recipient-configuration address book, in addition to the login status of the apparatuses. The relation is indicated by, for example, a transmission history from the user A to the user B, and whether the group accounts to which the users A and B belong is the same or not.

### Other Modifications

The image transmission system pertaining to the embodiments above may be applied as a method for transmitting image data, and a program realizing the method.

The program may be recorded on varieties of recording media from which data can be read with use of a computer. Such recording media include: a magnetic tape, a magnetic disc such as a flexible disc, optical discs such as a DVD, a CD-ROM, a CD-R, an MO, and a PD, and flash memory type recording media such as a Smart Media (registered trademark). The program may be produced and transferred, in the form of the aforementioned recording media. Alternatively, the program may be transmitted and supplied, in the form of the program itself, via a variety of wired/wireless network including the Internet, a broadcast, an electric communication circuit, and satellite communication.

Furthermore, it is not necessary that the program of the present invention includes all the modules for making a computer execute the aforementioned operations; for example, varieties of general programs individually installable to an information processing apparatus may be used to make a computer execute each operation of the present invention. The general programs include such as a communication program, and a program included in the operating system (OS). This means that the recording medium of the present invention does not have to contain all the aforementioned modules, nor transmit all the aforementioned modules. Still Further, a predetermined operation may be sometimes executed using dedicated hardware.

### Summary of Embodiments

(1) An aspect of the present invention is an image transmission system that includes a server and an image transmission apparatus as a client which are connectable to each other, the server comprising a storage storing therein identifiers of one or more recipients and addresses corresponding thereto, and the image transmission apparatus comprising: a first acquisition part operable to acquire the identifiers from the server; a menu display part operable to display a menu of selectable transmission destinations based on the acquired identifiers; a second acquisition part operable to acquire, from the server, one of the addresses corresponding to a selected one of the transmission destinations; and a transmission part operable to transmit data to the acquired one of the addresses.

(2) In the structure of (1), the server may further comprise a receiving part operable to receive, from a recipient, an address thereof, and the storage may further store therein the address of the recipient.

(3) In the structure of (1), the image transmission apparatus may further comprise an accepting part operable to accept a login of a user, and the first acquisition part may start acquiring the identifiers when the accepting part accepts the login.

With the stated structure, it is possible to prepare for displaying the menu that might be displayed after the login is accepted, by acquiring the identifiers at the time of the login. As a result, it is possible to realize smooth operations.

(4) In the structure of (1), the first acquisition part may acquire the identifiers without acquiring the addresses, and the menu display part may display the identifiers, and hide the addresses corresponding thereto.

With the stated structure, the first acquisition part does not acquire the address. As a result, the menu display part operable to smoothly display the items based only on the identifiers. Also, it is possible to handle the change to the address made after the first acquisition part acquires the address.

(5) In the structure of (1), the first acquisition part may acquire the identifiers and the addresses from the server, and the second acquisition part may acquire the one of the addresses if any changes have been made to the addresses acquired by the first acquisition part.

(6) In the structure of (1), the identifiers may be names of the recipients.

(7) In the structure of (1), the storage may store therein protocol information that shows transmission modes to be used for transmission to the addresses.

Although the present invention has been fully described by way of examples with reference to the accompanying drawings, it is to be noted that various changes and modifications will be apparent to those skilled in the art. Therefore, unless such changes and modifications depart from the scope of the present invention, they should be construed as being included therein.

What is claimed is:

1. An image transmission system that includes a server and an image transmission apparatus as a client which are connectable to each other,
the server comprising a storage storing therein identifiers of one or more recipients and addresses corresponding thereto, and
the image transmission apparatus comprising:
a first acquisition part operable to acquire the identifiers from the server;
a menu display part operable to display a menu of selectable transmission destinations based on the acquired identifiers;
a second acquisition part operable to acquire, from the server, one of the addresses corresponding to a selected one of the transmission destinations; and
a transmission part operable to transmit data to the acquired one of the addresses.

2. The image transmission system of claim 1, wherein
the server further comprises a receiving part operable to receive, from a recipient, an address thereof, and
the storage further stores therein the address of the recipient.

3. The image transmission system of claim 1, wherein
the image transmission apparatus further comprises an accepting part operable to accept a login of a user, and
the first acquisition part starts acquiring the identifiers when the accepting part accepts the login.

4. The image transmission system of claim 1, wherein
the first acquisition part acquires the identifiers without acquiring the addresses, and
the menu display part displays the identifiers, and hides the addresses corresponding thereto.

5. The image transmission system of claim 1, wherein
the first acquisition part acquires the identifiers and the addresses from the server, and
the second acquisition part acquires the one of the addresses if any changes have been made to the addresses acquired by the first acquisition part.

6. The image transmission system of claim 1, wherein
the identifiers are names of the recipients.

7. The image transmission system of claim 1, wherein
the storage stores therein protocol information that shows transmission modes to be used for transmission to the addresses.

8. An image transmission apparatus that is connectable to a server that stores therein identifiers of recipients and addresses corresponding thereto, the image transmission apparatus comprising:
a first acquisition part operable to acquire the identifiers from the server;
a menu display part operable to display a menu of selectable transmission destinations based on the acquired identifiers;
a second acquisition part operable to acquire, from the server, one of the addresses corresponding to a selected one of the transmission destinations; and
a transmission part operable to transmit data to the acquired one of the addresses.

9. An address server that is connectable to an image transmission apparatus as a client, the address server comprising:
a storage operable to store therein identifiers of one or more recipients and addresses corresponding thereto;
an accepting part operable to accept a change to the addresses;
a judgment part operable to judge whether the image transmission apparatus has possibilities of using the addresses that have not been changed; and
a transmission part operable to transmit the addresses that have been changed, to the image transmission apparatus if the judgment part judges affirmatively.
